(19) United States
(12) Patent Application Publication
(10) Pub. No.: US 2013/0045295 A1
(43) Pub. Date: Feb. 21, 2013

(54) MOLDING TOOL FOR THE PRODUCTION OF A TRANSPORT CONTAINER MADE OF PLASTIC

(71) Applicant: Axel RITZBERGER, Altendorf (CH)

(72) Inventor: Axel RITZBERGER, Altendorf (CH)

(73) Assignee: GEORG UTZ HOLDING AG, Bremgarten (CH)

(21) Appl. No.: 13/584,980

(22) Filed: Aug. 14, 2012

(30) Foreign Application Priority Data
Aug. 15, 2011 (DE) 10 2011 110 141.5

(51) Int. Cl. B29C 45/26

(52) U.S. Cl. 425/542

(57) ABSTRACT

A molding tool for the production of a transport container made of plastic, in an injection-molding machine, wherein one half of the mold tool is attached to a movable mold mounting plate and the other half to a fixed mold mounting plate. The fixed mold mounting plate has a sprue opening for a plastification and injection unit. The mold tool half that molds the exterior regions of the container is disposed on the movable mold mounting plate, and the mold tool half that molds the interior region of the container is disposed on the fixed mold mounting plate. In this mold tool half, sprue channels that proceed from the sprue opening run not only into the bottom region but also in the side wall region of the container to be injection-molded.

### CROSS REFERENCE TO RELATED APPLICATIONS

Applicant claims priority under 35 U.S.C. §119 of German Application No. 10 2011 110 141.5 filed Aug. 15, 2011, the disclosure of which is incorporated by reference.

### BACKGROUND OF THE INVENTION

The invention relates to a molding tool for the production of a transport container made of plastic, in an injection-molding machine. One half of the mold tool is attached to a movable mold mounting plate and the other half to a fixed mold mounting plate, and the fixed mold mounting plate has a sprue opening for a plastification and injection unit.

The plastic is melted using the plastification and injection unit, and injected into the cavity of the closed tool, where the plastic then cools off, takes on the contour of the cavity, and can then be unmolded.

In this connection, up to now the mold tool has been disposed in the machine in such a manner that the injection point(s) are situated on the bottom underside of the blank to be injection-molded. In this connection, the molded part can fundamentally be injection-molded centrally, by way of a sprue.

The flow path into the corners and, in addition, also all the way to the uppermost regions of the side walls, requires a high injection pressure, and with that great closing forces and large/expensive machines.

To reduce the injection pressure or the closing force, multiple injection points are often disposed in the corner regions, so that instead of one injection point in the center, four injection points are present in the corners, for example. With high side walls and long flow paths, a high injection pressure is required despite the injection points in the corners, thereby causing great tensions to occur in the injection-molded part, which can lead to deformations after unmolding, for example, or, in the case of HDPE, can actually lead to stress cracks. The force flow can be made worse as a result of deformations, and plastic parts can actually fail completely as a result of stress cracks.

It is possible to reduce the injection pressure in the side walls in that direct injection into the side wall takes place by way of the fixed tool half. However, in the case of the transport containers in question, it is not possible to have reinforcement ribs injection-molded onto the side walls, which ribs can run both vertically and horizontally and must be released after injection, in order to open the tool and to allow such unmolding.

This is because unmolding takes place by means of movable jaws. In the case of a transport container, such a jaw is required for each side wall; it is displaced laterally away from the molded part for unmolding.

The liquid plastic is distributed by way of a hot channel, as a standard procedure, which channel is passed around the bottom edge to the side wall, from the bottom region injection points. As soon as the jaw is moved outward for unmolding, the connection region that leads around the container edge would have to be interrupted. However, this is almost impossible, because seal problems would occur at injection pressures of up to 2000 bar.

For this reason, it has been proposed, in the published patent application P 10 2011 103 361.4, to reduce the injection pressure by expanding the mold cavity in the side wall region during injection of the liquid plastic, and afterward, displacing the jaws into the actual mold position, thereby optimizing the filling process of the mold cavity in the side wall regions, as well.

### SUMMARY OF THE INVENTION

It is therefore an object of the invention to configure a mold tool of the type indicated above in such a manner that a further significant reduction in the injection pressure can be achieved and nevertheless, optimal filling behavior is achieved all the way into the last angle of the mold cavity.

This object is accomplished by a molding tool having a the mold tool half that molds the exterior regions of the container, which half consists of a part that molds the bottom underside of the container and of four laterally displaceable jaws that mold the exterior surfaces of the side walls. This mold tool half is disposed on a movable mold mounting plate, and the mold tool half that molds the interior region of the container is disposed on a fixed mold mounting plate. In this mold tool half, sprue channels that proceed from the sprue opening run not only into the bottom region but also in the side wall region of the container to be injection-molded.

In other words, in contrast to the state of the art, the mold tool is rotated by 180°, so that the “core” that molds the interior surfaces of the container is disposed on the fixed mold mounting plate, and the plastic is injected by the plastification and injection unit, by way of the sprue opening, through the core into the mold cavity. In this connection, a channel system can be configured in such a manner that one channel proceeds from one or more injection points on the bottom top side and multiple channels proceed radially end in the interior side wall region.

By means of the combination of “mold cavity enlargement during injection” and “injection through the core,” it is possible to reduce the injection pressures to a significantly lower dimension.

This results in the following advantages:

injection pressures are reduced,

closing forces are reduced, so that smaller machines can be used,

tensions in the molded parts are reduced, so that fewer deformations and/or none occur, or reduced stress cracks occur in the case of HDPE,

raw materials can be processed that could not be used until now, because of lower flow capacity.

Therefore it is possible to achieve significantly better impact resistance values at lower temperatures, by using more impact-resistant raw materials.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows an injection-molding machine according to one embodiment of the invention;

FIG. 2 shows a sectional view of a portion of a mold tool according to the invention;

FIG. 3 shows a sectional view of a portion of a mold tool according to the state of the art; and

FIG. 4 shows a sectional view of a portion of an alternative embodiment according to the state of the art.

### DETAILED DESCRIPTION OF THE PREFERRED EMBODIMENT

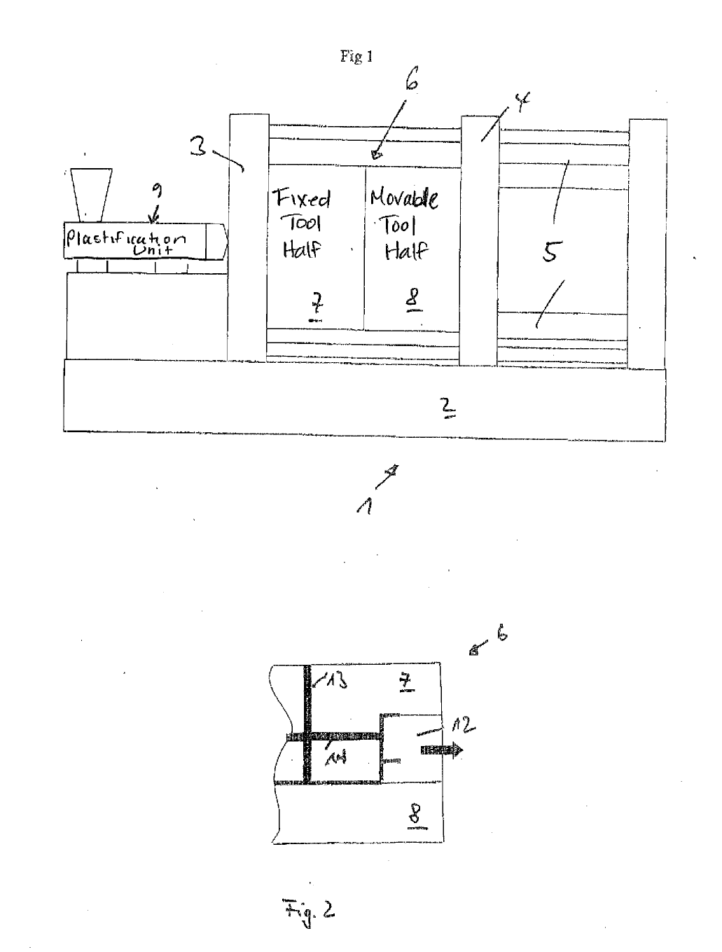

Referring now in detail to the drawings, FIG. 1 shows an injection-molding machine in a perspective representation which is provided, in general, with the reference symbol 1. It consists of a machine bed 2, a fixed mold mounting plate 3 disposed on machine bed 2, and a movable mold mounting plate 4 that is displaced by way of pressure-medium cylinders 5 that are only indicated, into the closed position.

The mold tool 6, which consists of a first tool half 7 that is disposed on the fixed mold mounting plate 3 and a second tool half 8 that is disposed on the movable mounting plate 4 is situated between the mold mounting plates 3 and 4. In the closed state of the mold tool, a mold cavity remains, into which the liquefied plastic is injected by way of a plastification and injection unit 9, through a sprue opening in the fixed mold mounting plate 3.

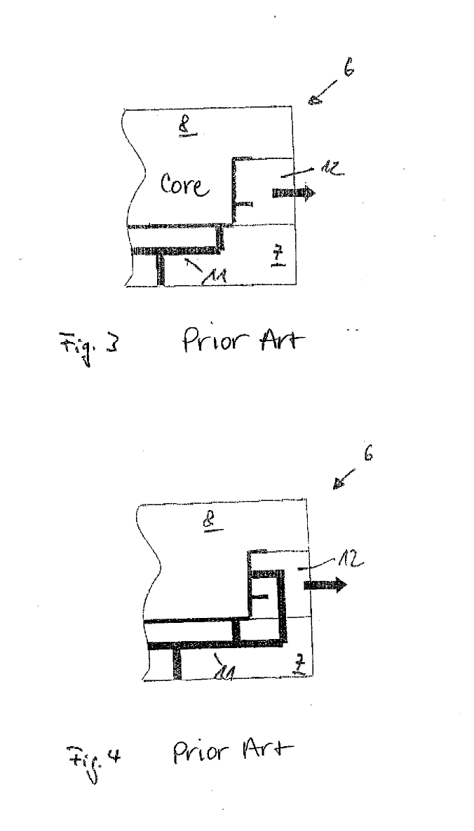

As is evident from FIG. 3, the liquid plastic is distributed, as a standard procedure, by way of a hot channel 11, in such a manner that multiple injection points are present in the corner regions of the bottom underside of the molded part to be injection-molded. However, not only is the bottom injection-molded by way of these injection points, but also, the liquid plastic must be able to penetrate all the way to the last edge of the side walls.

High injection pressures and closing forces are required for this. The suggestion has already been made to provide the jaws 12 that mold the exterior side walls with slides, and to move these away laterally to increase the size of the mold cavity, so that the liquid plastic can penetrate into this region without hindrance, and afterward, the slides are then displaced back into the final mold position.

A further deliberation consists in expanding the hot channel 11 in such a manner that a channel is guided around the edge of the blank all the way into the side wall region, as shown in FIG. 4.

As soon as the movable jaw 12 has been moved outward, the connection region in the hot channel 11 is interrupted, and this would lead to significant seal problems.

In FIG. 2, the solution according to the invention is shown. The mold tool 6 is rotated by 180° in the machine 1, so that the mold tool half 7, the core of which molds the interior surfaces of the container, is disposed on the fixed mold mounting plate 3, and the second tool half 8, with the jaws 12, on the movable mold mounting plate 4.

A sprue channel 13 runs from the sprue opening in the fixed mold mounting plate 3, perpendicular, all the way into the bottom region of the molded part to be molded, and further channels 14 proceed radially, horizontal to the side wall regions of the molded part to be molded, from the sprue channel 13.

In this manner, uncomplicated guidance to the injection points is obtained, which now all end on the interior surfaces of the blank to be molded.

In addition, in the case of this solution, the cavity enlargement process shown using FIG. 3 can also be applied.

Accordingly, while only a few embodiments of the present invention have been shown and described, it is obvious that many changes and modifications may be made thereunto without departing from the spirit and scope of the invention.

What is claimed is:

1. A molding tool for the production of a transport container made of plastic, in an injection-molding machine, comprising:
a mold tool half adapted for molding exterior regions of the container, which half consists of a part that molds a bottom underside of the container and of four laterally displaceable jaws that mold exterior surfaces of side walls, said mold tool half being attached to a movable mold mounting plate;
another mold tool half attached to a fixed mold mounting plate having a sprue opening for a plastification and injection unit, said another mold tool half being adapted to mold an interior region of the container, said another mold tool half having sprue channels that proceed from the sprue opening and run not only into a bottom region but also in a side wall region of the container to be injection-molded.

2. The mold tool according to claim 1, wherein the jaws are provided with grooves for molding reinforcement ribs in the side walls of the container.

3. The mold tool according to claim 1, wherein slides for temporary enlargement of the cavity are disposed at least one of the part that molds the bottom, and the jaws.
